(19) United States
(12) Patent Application Publication
(10) Pub. No.: US 2012/0305646 A1
(43) Pub. Date: Dec. 6, 2012

(54) Artificial Fingerprint

(75) Inventors: Alexandra Schweikart, Bayreuth (DE); Andreas Fery, Bayreuth (DE)

(73) Assignee: UNIVERSITAT BAYREUTH, Bayreuth (DE)

(21) Appl. No.: 13/514,664

(22) PCT Filed: Dec. 6, 2010
(86) PCT No.: PCT/EP2010/007400

§ 371 Date: Aug. 23, 2012

(30) Foreign Application Priority Data
Dec. 10, 2009 (EP) 09178648.3

(51) Int. Cl. G06K 19/00; B05D 3/12; B05D 5/00; G06K 7/00

(52) U.S. Cl. 235/435; 235/494; 427/171; 427/257

(57) ABSTRACT

An identification label with a three-dimensional wrinkled structure may be formed by depositing a hard film with a high elastic modulus on an elongated substrate of a lower elastic modulus. Wrinkles with defects develop as the substrate is subsequently allowed to relax. Defects such as ridge endings and ridge bifurcations are randomly distributed over the wrinkled surface, and allow to uniquely identify any given identification label with the high degree of accuracy. Since the formation of defects is a random process, the wrinkled structure cannot be reproduced or counterfeited. The labels are thus forgery-proof.

### FIELD OF THE INVENTION

The invention relates to the field of identification and/or authentification labels.

### BACKGROUND OF THE INVENTION AND RELATED PRIOR ART

Various techniques exist in the art for labeling an object such as a consumer article in a way that allows to reliably identify or authenticate the object, or to track its supply chain. Labels with one-dimensional or two-dimensional bar codes (two-dimensional bar codes are sometimes called “matrix codes”) have particularly wide currency today. They can be produced in high numbers and at low cost and can be read out easily and swiftly by means of laser scanners. Radio frequency identification (RFID) tags have more recently been introduced as electronic labels. They may contain an integrated circuit for storing and processing information and can be stimulated to emit a radio frequency signal when triggered with an external signal. The emitted radio frequency signal may comprise an ID that can be analyzed to identify the label. Some such tags can be read from several meters away and from beyond the line of sight of the reader.

However, both conventional printed labels and RFID tags have the disadvantage that they are relatively easy to copy or forge. Hence, they are generally not very useful for identifying or tracking counterfeit products, since the counterfeiter will usually fake the label alongside the product to which it is attached. Counterfeit products pose particular threats in sensitive areas such as pharmaceutical products or automotive spare parts. Moreover, they can seriously damage the reputation of the legitimate manufacturer, who may be held responsible for fake products of poor quality that bear his name. It is estimated that the total damage due to counterfeit products amounts to several dozen billion dollars each year, and is continuously rising. Therefore, anti-counterfeit labels are gaining increasing importance.

Electronic labels that implement encryption algorithms to protect the identification data have been developed to guard against counterfeiting, but are rather expensive and not fully forgery-proof. Watermarks, safety threads or holograms may also help to discourage counterfeiters and to identify forged goods. However, they again add to the cost of the product and can in principle likewise be copied or duplicated. Manufacturers have made the sad experience that counterfeiters are able to fake virtually any conventional identification or authentification tag if given sufficient time and resources, and will do so if they feel their efforts are justified by the value of the product.

German patent application DE 10 2004 002 410 A1 describes an identification label with a surface layer resulting from a microphase separation of a block copolymer. The surface has a random branching pattern that allows to uniquely identify the label. Since the pattern is random, it is very difficult to copy or counterfeit.

However, the patterns resulting from a microphase separation have a characteristic lengthscale that is determined by the underlying physical process and cannot be varied over a large range, thereby limiting the applicability of such labels. Moreover, the resulting structures differ widely and show only few regularities, which makes automated recognition and identification of such labels a formidable task. Since the individual patterns are complex, they each require considerable storage space. This can be a serious challenge if identification requires the comparison of a given pattern against a large number (maybe several millions) of other patterns.

European patent applications EP 1 990 212 A1 and EP 1 990 779 A2 disclose an identification label with a randomly patterned surface structure resulting from a microphase separation process. Image processing means are used to generate characteristic data of the pattern surface so that it can be used as a unique label which is difficult to copy or counterfeit.

It is hence the objective of the present invention to provide an improved identification label that is both forgery-proof and easy to read out and analyze.

### SUMMARY OF THE INVENTION

This objective is achieved by an identification label with the features of independent claim 1 as well as by the method of forming an identification label with the features of independent claim 11.

The invention also relates to a method of forming a labeled object according to independent claim 5 and a method of identifying an object according to independent claim 6, as well as to a detection device suitable for identifying a labeled object according to independent claim 15. The dependent claims relate to preferred embodiments.

An identification label according to the present invention has an upper surface comprising a three-dimensional periodically wrinkled structure with a plurality of defects. The defects are suitable for identifying said label. In one embodiment, the surface density of said defects is no smaller than 10,000 per mm², preferably no smaller than 20,000 per mm². In a preferred embodiment, the surface density is no smaller than 0.03 per λ², preferably no smaller than 0.06 per λ², wherein λ is a spatial period in a periodically wrinkled surface structure. However, the invention is not limited to these defect surface densities.

The defects of a three-dimensional wrinkled structure are relatively easy to identify and analyze, but are at the same time very difficult to forge. Thus, a three-dimensional wrinkled structure is ideally suited as an identification or authentification label.

A large film with a three-dimensional wrinkled structure can be produced, and can be cut into a large number of smaller surface pieces, each of which having an individual three-dimensional wrinkled structure with a plurality of defects with a unique defect pattern. These pieces may serve as the upper surface of an identification label. The structure and defect pattern of each label can be analyzed and stored in a data base for later identification, similar to the storage and comparison of human fingerprints. Once such a defect pattern has been assigned to an identification label, the product or article to which the identification label has been attached can be reliably tracked and identified by analysis of its defects and comparison with the pre-stored patterns in the data base.

The inventors have successfully produced and tested identification labels with a surface density of said defects exceeding of 10,000 per mm² or even 20,000 per mm², and found that they may still reliably detect and analyze said defects. Since the surface density can be chosen to be large, the identification labels can be small while still allowing a reliable identification. For instance, identification labels according to the present invention may have a surface size in the range of only 100 μm×100 μm, or even smaller. Labels of this size are suitable for attachment even to minute products, and do not disturb when attached to the packaging of larger consumer articles. In fact, labels of this size are hardly visible with the naked eye.

In a particularly preferred embodiment, the surface density of said defects is no smaller than 40,000 per mm², allowing for even smaller identification labels.

Since the identification labels can be small and can be manufactured at large scale, production costs of any one label are almost negligible.

If the three-dimensional wrinkled structure is a periodically wrinkled surface structure with a spatial period λ, defects can be reliably detected and analyzed even if the surface density of said defects exceeds 0.03 per λ², or even 0.06 per λ². A periodically wrinkled surface structure has the advantage of a particularly high contrast between the defects and an ambient regular surface structure. As a consequence, even very small labels can be identified with a high degree of reliability. The spatial period λ of a periodically wrinkled surface structure, as used herein, may refer to the distance between two neighboring ridges of said wrinkled structure.

According to a particularly preferred embodiment, the density of said defects is no smaller than 0.09 per λ². This allows to chose the surface size of the identification label even smaller while still permitting to reliably distinguish between a large number of different labels. Viewed from a different angle, a larger set of identification labels may be distinguished for labels of a given surface size.

The inventors found that reliable identification of periodically wrinkled surface structures is possible over a large range of the spatial period λ. This allows to scale the size of the identification label depending on the specific application and/or the size of the product for which it is intended. Preferably, the spatial period λ may be in the range of 10 nm to 100 μm, preferably 70 nm to 50 μm.

According to a preferred embodiment, said defects are randomly distributed over said surface, or appear to be randomly distributed over said surface.

Since the defects are or appear to be randomly distributed, reproduction of a given identification label is practically impossible. Hence, the identification labels are forgery-proof.

According to this embodiment, the protection against counterfeiting may hence rely on the fact that the formation of defects on a wrinkled structure is usually a stochastic process, so that the exact locations at which defects form, and the size and type of these defect cannot be reliably forecast. Hence, the invention can be employed even for wrinkled structures in which the microscopic processes that govern the formation of defects are not or at least not fully understood.

However, the invention is equally effective for wrinkled structures in which the microscopic processes leading to the formation of defects is partially or fully understood, and the locations at which defects form can be influenced by the manufacturer, as long as the information about the relevant parameters is not available to the potential counterfeiters, and the defects appear to be randomly distributed to them. As used throughout this application, defects that appear to be randomly distributed over the surface may be defects that appear uncorrelated when subjected to conventional stochastic analysis.

According to a preferred embodiment, the defects comprise at least one ridge ending and/or at least one ridge bifurcation.

A ridge ending may be a defect in which a ridge does not extend from one side of the wrinkled structure to the other, but terminates in a steep decline from an elevated position to the low-lying surroundings. A ridge ending can be easily detected by conventional detection methods, and hence contributes to an accurate and reliable identification of the label.

A ridge bifurcation may be a position on the three-dimensional wrinkled structure in which at least two ridges bifurcate or join, and likewise stands out clearly against the ambient surface structure. It is thus equally suitable for identifying the label.

Ridge endings and ridge bifurcations similar to those of the present invention are conventionally used for the identification of human fingerprints, and hence reliable analyzation and identification algorithms for these types of defects already exist in the art.

In a preferred embodiment, the wrinkled structure comprises a plurality of ridges, wherein neighboring ridges are essentially parallel at least along a portion thereof.

According to a further embodiment, said wrinkled structure is periodically wrinkled at least in a portion of said surface.

Defects stand out more pronouncedly against a regular or periodic background. Hence, a regularly or periodically wrinkled structure helps to enhance the reliability and accuracy of the detection of the defects.

In a preferred embodiment of the invention, the identification label comprises a substrate layer of a first material having a first elastic modulus and a cover layer of a second material having a second elastic modulus greater than said first elastic modulus, wherein said cover layer is formed on said substrate layer and has said surface.

By combining materials with different elastic moduli, a three-dimensional wrinkled structure with a plurality of defects may conveniently be formed by means of concerted relaxation.

Depending on the specific application, a large variety of different materials may be combined as first and second material, wherein the elastic modulus of the cover layer is preferably larger than the elastic modulus of the substrate layer. For instance, the substrate layer may be formed from rubber or caoutchouc such as polydimethylsiloxane (PDMS) or any other elastomere, while the cover layer may be formed from a variety of materials including metals, polymers, or silica such as SiO₂.

According to a preferred embodiment, a ratio of said second elastic modulus and said first elastic modulus is no smaller than 200, and preferably no smaller than 400. If the second material is much stiffer than the first material, relaxation of the first material leads to the formation of a regular wrinkled structure on the surface of the cover layer.

A thickness of said cover layer can be much smaller than a thickness of said substrate layer, and preferably at least ten times smaller.

The invention also relates to a method of forming a labeled object, comprising the step of marking said object with an identification label having an upper surface comprising a three-dimensional periodically wrinkled structure with a plurality of defects, said defects suitable for identifying said label.

Said object may be a consumer article, for example the headlight of a car or a bottle containing medicine, or its cover or packaging, or any other article that should be labeled and identified. As described above, defects of a three-dimensional wrinkled structure allow to reliably and uniquely identify the label, and hence the product to which it is attached.

The invention further relates to a method of identifying an object, said object being marked with an identification label having an upper surface comprising a three-dimensional periodically wrinkled structure with a plurality of defects, said method comprising the step of detecting at least a portion of said defects.

The number of defects on the identification label that are selected for analysis and identification depends on the specific application, for instance on the number of identification labels that should be distinguished, or on the desired level of accuracy. Experiments conducted by the inventors have shown that only ten to twenty different defects are often sufficient to identify a given label with a very high degree of accuracy.

In a preferred embodiment, detecting said defects comprises the step of determining the absolute positions of said defects on said surface and/or determining their relative positions.

Determining the absolute and/or relative positions of the defects allows to generate a defect pattern characterizing or representing the identification label, which can be stored in a database and can later be compared against other such defect patterns for identification.

According to a preferred embodiment, detecting said defects comprises a step of distinguishing ridge endings from ridge bifurcations.

Since both types of defects can be easily distinguished from one another on a three-dimensional wrinkled structure, identifying both types separately enhances the accuracy of the label identification.

According to a preferred embodiment, detecting said defects comprises a step of identifying at least one ridge ending, and determining a tangential direction of said ridge ending.

A tangential direction of the ridge ending may be the direction of a tangent to the ridge at the point where the ridge terminates, measured against a predefined direction. A tangential direction can be easily and reliably determined in a three-dimensional wrinkled structure, and can be employed to identify a label with a high degree of accuracy.

According to a further embodiment, detecting said defects comprises a step of identifying at least one ridge bifurcation, and determining an angle between two ridge lines forming said ridge bifurcation.

An angle between the ridge lines can be conveniently determined, and reliably characterizes the identification label.

According to a preferred embodiment, the method comprises the step of detecting said defects optically and/or capacitively and/or by means of atomic force microscopy (AFM). All these detection techniques allow to reliably identify and characterize said defects. Depending on the circumstances such as the size of the identification label, the type and dimensions of the defects, and/or the spatial period in a periodically wrinkled surface structure, either optical or capacitive detection or detection by means of atomic force microscopy may be more preferable.

The method according to the present invention may also comprise the step of generating a defect pattern from said detected defects, said defect pattern representing said defects.

The method may further comprise the step of comparing said detected defects or defect pattern against a set of pre-stored defects or defect patterns.

As described above, a comparison of defect patterns allows to swiftly and reliably identify a given identification label, and hence the product to which it is attached.

The invention further relates to a method of forming an identification label with an upper surface comprising a three-dimensional wrinkled structure with a plurality of defects, said method comprising the steps of: forming a substrate layer of a first material having a first elastic modulus; stretching said substrate layer by applying a stress at least along a first longitudinal direction; forming a cover layer of a second material on said stretched substrate layer, said second material having a second elastic modulus greater than said first elastic modulus; and relaxing said substrate layer such that a wrinkled structure with a plurality of defects is formed.

The method according to the invention provides an efficient means of generating identification labels with a three-dimensional wrinkled structure in large quantities. By controlling the process parameters of at least one of said method steps, the surface density of said defects can be adjusted.

According to a preferred embodiment, forming said defects comprises the step of controlling a relaxation velocity.

The inventors have learned from experiments that the relaxation velocity is a very important parameter in determining the surface density of said defects on the wrinkled structure. Generally speaking, the higher the relaxation velocity, the larger the surface density of the defects formed on said wrinkled structure. A careful choice of the relaxation velocity results in identification labels which maintain a regular structure, while still having a sufficiently large number of defects to allow a reliable identification of even very small labels.

In an embodiment of the invention, said relaxation velocity is controlled to be no smaller than 3 μm/s, and preferably no smaller than 10 μm/s. The inventors have found that particularly advantageous results can be achieved with a relaxation velocity no smaller than 30 μm/s.

According to a further preferred embodiment, forming said defects comprises the step of controlling said stress and/or controlling a height of said substrate layer and/or controlling a height of said cover layer and/or selecting said first elastic modulus and/or selecting said second elastic modulus.

The label may be an identification label with some or all of the features described above.

The invention also relates to a detection device suitable for identifying an object marked with an identification label according to a method comprising some or all of the features described above.

### DETAILED DESCRIPTION OF A PREFERRED EMBODIMENT

The numerous features and advantages of the present invention will best be understood and appreciated from a detailed description of the accompanying figures, in which:

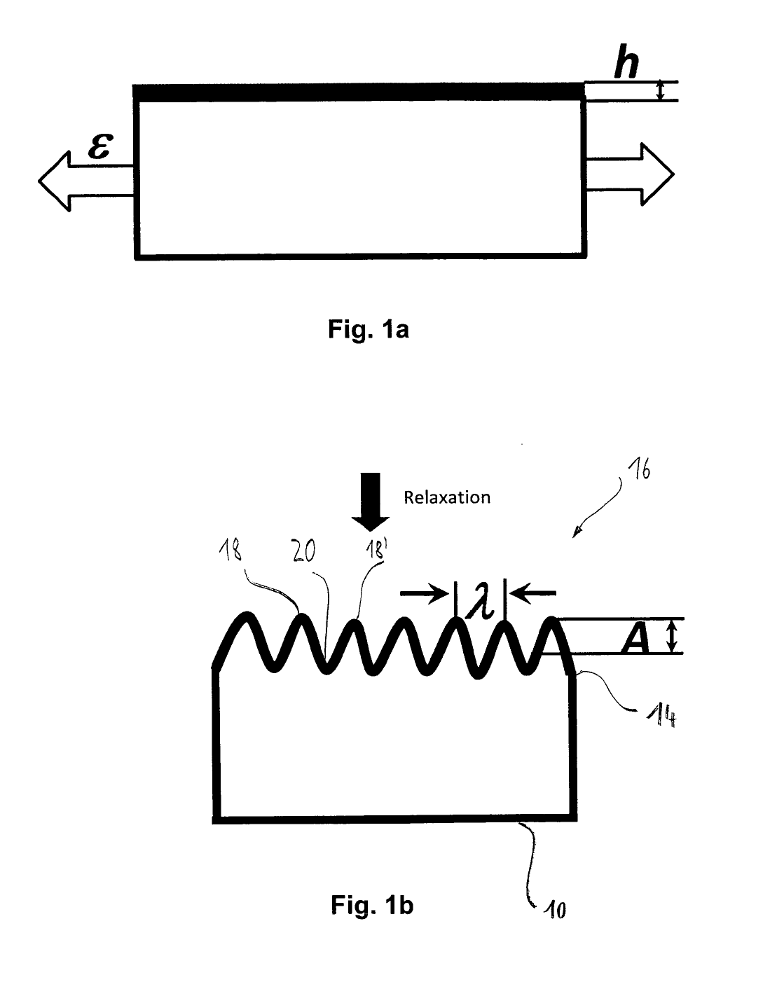

FIG. 1a illustrates a method of forming an identification label according to an embodiment of the present invention;

FIG. 1b schematically shows the structure of an identification label according to the present invention in a perspective illustration;

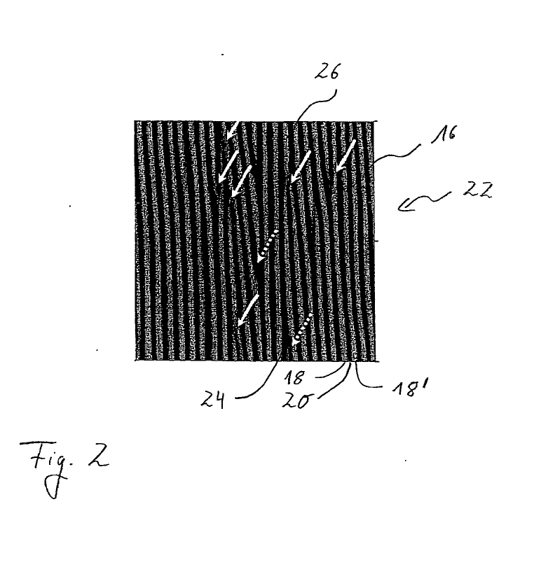

FIG. 2 is an AFM top view of an identification label according to the present invention, wherein defects suitable for identifying the label are indicated by arrows;

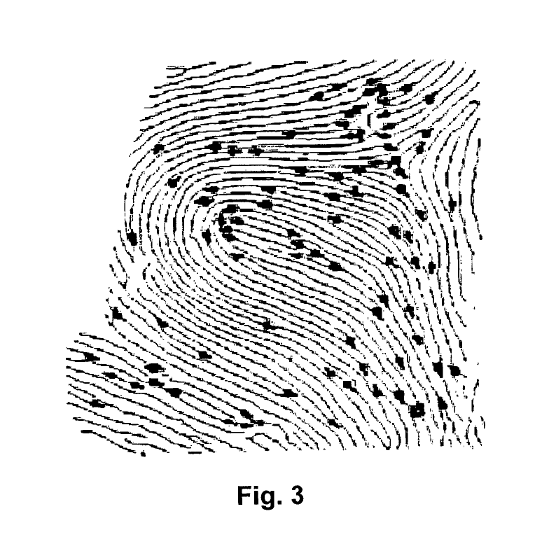

FIG. 3 is a sketch of a portion of a human fingerprint, for ease of comparison;

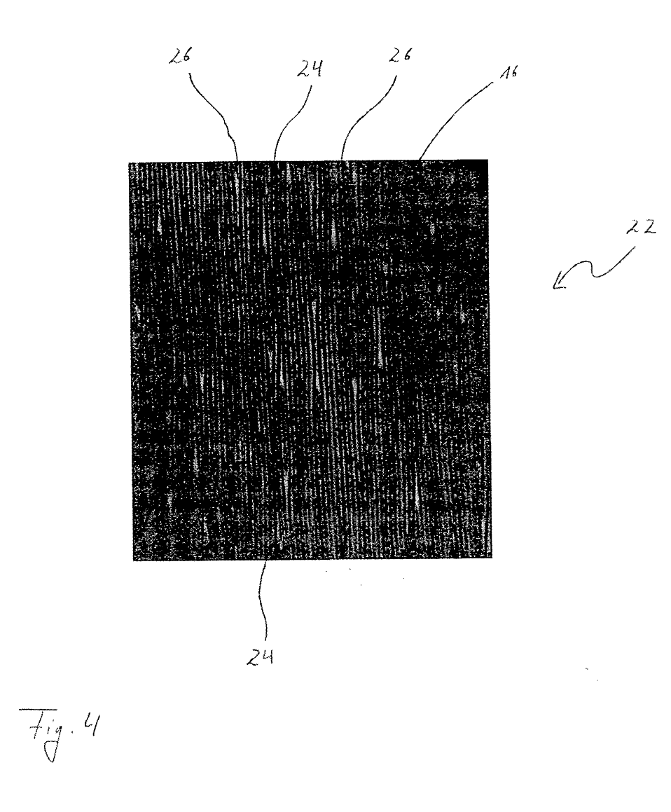

FIG. 4 is a reflected-light top view of an identification label according to the present invention;

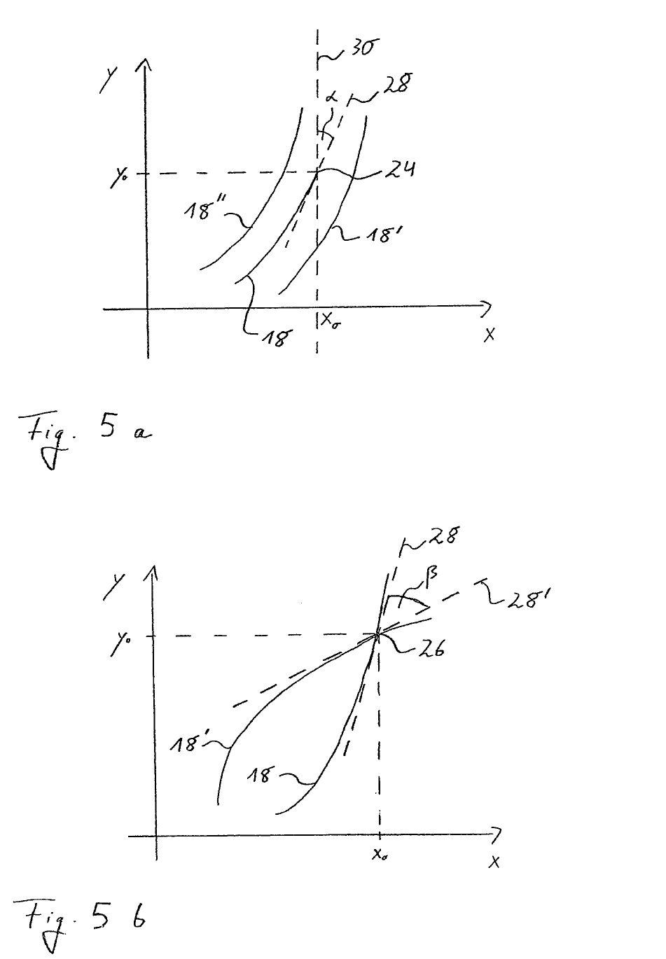

FIG. 5a illustrates a method of analyzing and/or identifying a ridge ending in an identification label according to the present invention; and

FIG. 5b illustrates a method of analyzing and/or identifying a ridge bifurcation in an identification label according to the present invention.

Wrinkles are known to develop when a thin, hard film formed on a soft substrate is subjected to a compressing force. This general principle can be employed to form the wrinkled structure of an identification or authentification label according to the present invention. An exemplary method will now be explained with reference to FIG. 1a.

A substrate layer 10 of an elastic material such as polydimethylsiloxane (PDMS) is formed and subjected to a stress along a first longitudinal direction indicated by arrows 12, 12′. The stress results in a strain or an elongation of the substrate layer 10 along the first longitudinal direction by a factor ∈, e.g. ∈=20%. In FIG. 1a, the substrate layer 10 is shown in this elongated state. Once the substrate layer 10 has been elongated, a cover layer 14 is formed on a top surface of the substrate layer 10 so that it binds to the substrate layer 10. For instance, the cover layer 14 may be a hard film formed by exposition of the PDMS elastomer to an oxygen plasma, resulting in the formation of an SiO₂-like thin layer with uniform thickness h. The thickness h can be fine-tuned by variation of the plasma exposure dose (exposure time multiplied by plasma power). Usually, the thickness h of the cover layer 14 is chosen to be much smaller, for instance more than 2,000 times smaller, and preferably more than 20,000 times smaller, than the thickness D of the substrate layer 10. In the example illustrated in FIG. 1a, the thickness h of the cover layer 14 may be chosen to be in the range of 1 to 100 nm, and preferably in the range of 5 to 10 nm, while the thickness D of the substrate layer is usually chosen to be in the range of 0.01 to 3 mm, and preferably between 0.1 and 2 mm.

The materials involved are selected such that the elastic modulus of the cover layer 14 along the first longitudinal direction 12, 12′ is much larger than the elastic modulus of the substrate layer 10.

An elastic modulus (or modus of elasticity) is a parameter which characterizes an object's tendency to be deformed elastically when a force is applied to it. Generally, the elastic modulus E of an object can be understood as the slope of its stress-strain-curve, i.e.

$$E = \frac{stress}{strain} . \qquad ( 1 )$$

Stress is the force causing the deformation divided by the area to which the force is applied, while strain is the ratio of the change in length (caused by the stress) to the original length of the object.

For instance, if the cover layer 14 is composed of silica, the cover layer 14 can have an elastic modulus of about 40 Gigapascal, whereas the elastic modulus of PDMS is only in the range of 1.3 to 1.5 Megapascal, resulting in a ratio of 26,000 to 30,000.

Once the cover layer 14 has been formed on the substrate layer 10, the expanding force on the substrate layer 10 may be (gradually) released, and the substrate layer 10 is hence allowed to relax along the first longitudinal direction.

Due to the relaxation, the cover layer 14 formed on the upper surface of the substrate layer 10 contracts. Since the cover layer 14 is much stiffer than the substrate layer 10, wrinkles develop in the cover layer. This results in a wrinkled structure 16 schematically shown in FIG. 1b. The wrinkled structure 16 comprises of a plurality of ridges 18 that extend in a direction essentially perpendicular to the first longitudinal direction 12, 12′. Any two neighboring ridges 18, 18′ are separated by a valley 20. FIG. 1b illustrates a periodically wrinkled surface structure 16, in which any two neighboring ridges 18, 18′ of the wrinkled structures 16 are separated by the same distance λ, measured in a direction perpendicular to the ridges.

The inventors found that plasma doses between 4.8 and 55 kW result in wrinkle periodicities λ in the range of between 302±20 nm and 931±53 nm, while the amplitude A measuring the height of the ridges 18, 18′ varies between 25±2 nm and 200±19 nm (for a strain ∈=20%).

In the case of a uni-axial strain, one expects that the wrinkle wavelength λ follows an analytical dependency on the substrate's and the film's mechanical properties as well as the film thickness:

$$λ = 2 π {h ( \frac{( 1 - {v}_{s}^{2} ) {E}_{f}}{3 ( 1 - {v}_{f}^{2} ) {E}_{s}} )}^{\frac{1}{3}} . \qquad ( 2 )$$

In Eq. (2), E_{f} and Eₛ denote Young's elastic modulus of the cover film layer 14 and the substrate layer 10, respectively, while υ_{f} and υₛ denote their respective Poisson ratios. A Poisson ratio can be defined as the ratio of the contraction or transverse strain (perpendicular to the applied load) to the extension or axial strain (in the direction of the applied load). As before, h denotes the height of the cover film layer 14.

Eq. (2) shows that the periodicity λ of the wrinkled structure 16 may be controlled by appropriately selecting the film thickness h, and by choosing substrate and cover materials with appropriate Young modulus and Poisson ratio, respectively. This allows to vary the winkling periodicity over a wide range. For instance, the higher the ratio E_{f}/Eₛ and the larger the thickness h, the higher the wrinkling periodicity λ.

However, the present invention is not limited to periodically wrinkled structures as the one shown in FIG. 1b. Different wrinkled structures may be formed by adjusting the elongation and relaxation parameters. For instance, the substrate layer 10 may be subjected to multi-axial strain before deposition of the cover layer 14 by simultaneously deforming it along the first longitudinal direction 12, 12′ and a second longitudinal direction different from said first longitudinal direction. Likewise, the substrate layer 10 may be subjected to a shearing force before depositing the cover layer 14. Under these conditions, subsequent relaxation will result in wrinkled patterns that are more complex than the periodic structure 16 described with reference to FIG. 1b above, but may likewise be employed for labeling in the context of the present invention.

Apart from the specific examples described above, a large number of different materials may be employed as the substrate layer 10 and the cover layer 14, respectively. For instance, the substrate layer 10 may be formed from any elastic material, in particular from any elastomer or thermoplastic. Examples include, among others, polystyrole, poly(methyl methacrylate) (PMMA), or polyethylene terephthalate (PET). The cover layer 14 may be formed from a metal, polymer, polyelectrolyte or silica. The ratio of the elastic modulus of the cover layer 14 and the elastic modulus of the substrate layer 10 is preferably chosen to be no smaller than 400, and may be as high as 30,000 or more.

The method of forming a wrinkled surface structure 16 as described above is explained in greater detail in the research article “A Lithography-Free Pathway for Chemical Microstructuring of Macromolecules from Aqueous Solution Based on Wrinkling” by Melanie Pretzl et al., Langmuir 2008, 24, 12748-12753. In Pretzl et al., wrinkled surfaces are manufactured to serve as stamps for the transfer of ultrathin layers to surfaces such as a multilayer coated glass slide. This is advertised as a novel approach for submicron structuring of polyelectrolytes (including proteins) by microcontact printing. These applications require regularly, periodically wrinkled structures with as few defects as possible.

It is the surprising realization of the present inventors that (usually unwanted) defects can be brought to a practical use: by carefully controlling the process parameters, a wrinkled structure with randomly distributed defects of a predetermined surface density may be formed such that the defects are suitable for reliably identifying the structure. The defects may result when the system minimizes its total elastic energy during the relaxation process. Since such defects appear at random positions on the surface of the cover layer 14, each piece or portion of the wrinkled structure 16 has a unique defect structure, which can be used to identify this piece and to distinguish it from other portions with different defect structures. This allows to use the wrinkled structure 16 as an identification or authentification label, as will now be described.

By the technique described above, a wrinkled structure 16 with defects may be formed in large foils, which may be cut into smaller pieces that may serve as individual identification labels. The defect structure of each of the individual pieces may be analyzed optically or capacitively, and a defect pattern representing the defects may be derived. This defect pattern may be stored in a database. The pieces may then be attached (e.g. by gluing) to an object such as a consumer article or its packaging or covering, or any other object suitable for labeling.

For identification, the identification label may later be read, its defect pattern may be derived and compared against the pre-stored list of defect patterns. Since each such defect pattern is unique, the corresponding label (and hence the article or object to which it is attached) may be reliably identified. This allows to follow and track the supply chain of the article. Since the defect pattern of the label is random, it cannot be copied. Hence, counterfeited goods may be reliably detected. An atomic force microscopy (AFM) scan of (part of) an identification label 22 according to the present invention is shown in FIG. 2. The figure shows the topography of the sample surface in grayscale, with lighter colors corresponding to elevated portions and darker colors corresponding to low-lying portions of the surface. As can be read from FIG. 2, the identification label 22 has a wrinkled structure 16 with an essentially regular and periodic array of ridges 18 extending from one side of the identification label 22 to the other. The ridges 18 essentially run in parallel, wherein any two neighboring ridges 18 are separated by a valley 20. The wrinkle wavelength of the structure amounts to λ≈420 nm, and the amplitude λ≈60 nm.

However, compared to the ideal (defect-free) structure shown in FIG. 1b, the wrinkled surface 16 of the identification label 22 is not entirely regular, but comprises a number of defects. Two different kinds of defects are illustrated in FIG. 2. Ridge endings 24, in which a ridge abruptly terminates and steeply descents into the surrounding valley are indicated by dotted arrows, while bifurcations 26, in which two neighbouring ridges combine or separate, are indicated by solid arrows.

The example of FIG. 2 shows two ridge endings 24 and six ridge bifurcations 26. However, the ratio of the number of ridge endings to the number of ridge bifurcations appearing on any given piece of wrinkled structure is random. The positions at which the ridge endings 24 and the ridge bifurcations 26 form are likewise randomly distributed over the surface of the identification label, and cannot be predicted.

The resulting pattern is reminiscent of a human fingerprint, which likewise has a wrinkled surface structure with ridge endings and ridge bifurcations. For the ease of comparison, an example of a human fingerprint is shown in FIG. 3.

The similarities between the wrinkled structure of an identification label according to the present invention and a human fingerprint allows to apply the well-proven and established techniques for fingerprint identification in the context of the present invention. For instance, the three-dimensional nanostructure shown in FIG. 2 may be subjected to incident light of a suitable wavelength, and a reflected image may be collected by a CCD camera and stored as a digital image, from which ridge endings 24 and ridge bifurcations 26 may be identified.

FIG. 4 shows a reflected-light microscopic view of a larger surface portion of the sample illustrated in FIG. 2, in only 20-fold magnification. When viewed through an optical microscope, the light reflected from the ridges 18, 18′ results in bright stripes, while the valleys 20 appear in relative darkness, similarly to the AFM scan of FIG. 2. Ridge bifurcations 26 have a higher intensity than ridge endings 24, and hence these types of defects can be reliably distinguished even in a microscopic view of only limited resolution.

Alternatively, the three-dimensional wrinkled structure may be analysed capacitively, wherein the ridges serve as a dielectric medium that modify the electric field in an electric capacitor. Again, ridge endings 24 and ridge bifurcations 26 may be identified and distinguished for later analysis.

Ridge endings and ridge bifurcations stand out particularly well against the surrounding regular structure of the identification label 22, and are hence very suitable for identification. However, in principle any other type of defect may likewise be employed to identify the label 22.

Analysis of the identification label may be performed by determining the positions of the ridge endings 24 and ridge bifurcations 26 on the identification label 22. The ridge endings 24 may then be distinguished from the ridge bifurcations 26, and may be analyzed in additional detail.

An exemplary analysis of a ridge ending 24 will now be described with reference to FIG. 5a. The illustration shows three neighbouring ridges 18, 18′, 18″ extending along curved lines on a wrinkled structure 16. The ridge 18 terminates abruptly in a ridge ending 24, whereas the ridges 18′, 18″ extend further along the wrinkled structure 16. In a first step, the location (x₀, y₀) of the ridge ending 24 in a two-dimensional coordinate system representing the surface of the wrinkled structure 16 is determined. Subsequently, the ridge ending 24 is further analyzed to determine the angle α between a tangent line 28 to the ridge 18 at the ridge ending 24 and a predetermined direction 30 (for instance a direction perpendicular to the x axis of the coordinate system).

An exemplary method of analyzing a ridge bifurcation 26 will now be described with reference to FIG. 5b. The illustration shows two ridge lines 18, 18′ intersecting in a ridge bifurcation 26. In a first step, the position (x₀, y₀) of the ridge bifurcation 26 in a two-dimensional coordinate system covering the wrinkled structure 16 is determined. The ridge bifurcation 26 can be further characterized by means of the angle β between the tangent lines 28, 28′ of the ridges 18, 18′ at the location of the ridge bifurcation 26.

Analysis of a selected number of such defects of the wrinkled structure 16 results in a defect pattern that can later be compared with other defect patterns for identification of the label. The higher the number of identification labels that need to be distinguished, the more defects should be analyzed and identified on any given identification label.

The inventors found that the surface density of the defects on the identification label 22 can conveniently be manipulated by adjusting the velocity of the relaxation process explained with reference to FIG. 1a and 1b. For instance, a constant relaxation velocity of 0.04 mm/s has been found to result in a defect density of approximately 15,600 per mm², while a relaxation velocity of 2.5 mm/s results in a defect density of approximately 41,875 per mm² (both exemplary figures for the composition described with reference to FIGS. 1a and 1b).

From experiments, the inventors have learned that the identification and characterization of approximately 50 to 100 defects is already sufficient to identify and distinguish between several million identification labels with a very high accuracy. Hence, by suitably adjusting the relaxation velocity, the present invention allows for a reliable identification with very small identification labels, for example identification labels of a surface of only 100 μm×100 μm, or even significantly less.

The present invention offers a considerable number of advantages over conventional identification and authentification labels.

A label that does not comprise an electronic circuit but consists of a three-dimensional structure has the advantage that it cannot be emulated or copied by means of an integrated circuit.

On the other hand, the three-dimensional wrinkled surface structure according to the present invention is ideally suited for conventional pattern detection and pattern analysis means such as those developed for conventional fingerprint identification and comparison.

The defect structure of a wrinkled surface according to the invention is unique, and hence allows for a convenient identification. At the same time, the defect pattern is random and non-reproducable, and hence cannot be easily copied or counterfeited.

The wrinkled structure according to the present invention may be formed on a thin flexible foil, which can be attached to virtually any surface of almost any shape.

As described above, the identification labels can be made very small, and hence can be employed to label minute items or can be hidden on the surface or packaging of larger items.

The identification labels according to the present invention can be formed to be transparent and heat resistant up to temperatures of more than 300° C. In addition, the labels are non-toxic.

The labels can be manufactured easily and in large numbers at low costs. Still, they are at least as forgery-proof as conventional high-tech labels such as those based on RFID chips.

The examples described above and the drawings merely serve to illustrate the invention and its advantages over the prior art, and should not be understood as a limitation in any sense. The scope of the invention is solely determined by the appended set of claims.

### REFERENCE SIGNS

10 substrate layer
12, 12′ first longitudinal direction
14 cover layer
16 wrinkled structure
18, 18′, 18″ ridges of wrinkled structure 16
20 valley of wrinkled structure 16
22 identification label
24 ridge ending
26 ridge bifurcation
28, 28′ tangent to ridges 18, 18′
30 predetermined direction

1.-15. (canceled)

16. An identification label with an upper surface comprising a three-dimensional periodically wrinkled structure with a plurality of defects, said defects having a predetermined surface density and being suitable for identifying said label, said surface density of said defects being no smaller than 10,000 per mm².

17. The identification label of claim 16, wherein said density of labels is not smaller than 20,000 per mm².

18. The identification label of claim 16, wherein said surface density of said defects being no smaller than 0.03 per λ², wherein λ is a spatial period in the periodically wrinkled surface structure.

19. The identification label of claim 16, wherein said defects appear to be randomly distributed over said surface.

20. The identification label of claim 16, wherein said defects comprise at least one of a ridge ending and a ridge bifurcation.

21. The identification label of claim 16, with a substrate layer of a first material having a first elastic modulus and a cover layer of a second material having a second elastic modulus greater than said first elastic modulus, wherein said cover layer is formed on said substrate layer and has said surface.

22. A method of forming a labeled object, comprising the step of marking said object with an identification label having an upper surface comprising a three-dimensional periodically wrinkled structure with a plurality of defects, said defects suitable for identifying said label.

23. A method of identifying an object, said object being marked with an identification label having an upper surface comprising a three-dimensional periodically wrinkled structure with a plurality of defects, said method comprising the step of detecting at least a portion of said defects.

24. The method according to claim 23, wherein detecting said defects comprises the step of determining the absolute positions of said defects on said surface and/or determining their relative positions.

25. The method according to claim 23, wherein detecting said defects comprises the step of distinguishing ridge endings from ridge bifurcations.

26. The method according to claim 23, wherein detecting said defects comprises the step of identifying at least one ridge ending, and determining a tangential direction of said ridge ending.

27. The method according to claim 23, wherein detecting said defects comprises the step of identifying at least one ridge bifurcation, and determining an angle between two ridge lines forming said ridge bifurcation.

28. A detection device suitable for identifying an object marked with an identification label according to the method of any of claims 23-27.

29. A method of forming an identification label with an upper surface comprising a three-dimensional wrinkled structure with a plurality of defects, said method comprising:
forming a substrate layer of a first material having a first elastic modulus;
stretching said substrate layer by applying a stress at least along a first longitudinal direction;
forming a cover layer of a second material on said stretched substrate layer, said second material having a second elastic modulus greater than said first elastic modulus; and
relaxing said substrate layer such that a wrinkled structure with a plurality of defects is formed.

30. The method according to claim 29, wherein forming said defects comprises the step of controlling a relaxation velocity.

31. The method according to claim 30, wherein said relaxation velocity is controlled to be no smaller than 3 μm/s.

32. The method according to claim 31, wherein said relaxation velocity is controlled to be no smaller than 10 μm/s.
